(19) United States
(12) Patent Application Publication
(10) Pub. No.: US 2015/0114043 A1
(43) Pub. Date: Apr. 30, 2015

(54) MOLD, PROCESS AND APPARATUS FOR LASER-ASSISTED GLASS FORMING

(71) Applicant: Schott AG, Mainz (DE)

(72) Inventors: Thomas Risch, Mainz (DE); Georg Haselhorst, Schmitten (DE); Volker Plapper, Alzey (DE)

(21) Appl. No.: 14/383,144

(22) PCT Filed: Feb. 11, 2013
(86) PCT No.: PCT/EP2013/052704

§ 371 Date: Jan. 16, 2015

(30) Foreign Application Priority Data
Mar. 8, 2012 (DE) 10 2012 101 948.7

(51) Int. Cl. C03B 23/043; C03B 23/045; C03B 23/09; C03B 23/049

(52) U.S. Cl. CPC C03B 23/043; C03B 23/0496; C03B 23/045; C03B 23/092
USPC 65/29.18; 65/277; 65/162; 65/374.13; 65/109

(57) ABSTRACT

An apparatus is provided that heats the glass of a primary glass product to be formed. The apparatus includes a laser that emits light at a wavelength for which the glass of the primary glass product is at most partly transparent, such that the light is absorbed at least partially in the glass. The apparatus also includes a mold having a forming mandrel having a thermally stable ceramic material, at least in the region that forms the contact surface with the glass during the forming process.

The invention relates, in general, to the manufacture of glass products. In particular, the invention relates to the manufacture of glass products preferably formed as hollow bodies by laser-assisted hot forming, in which a mold, comprising a forming mandrel, is used. The forming mandrel preferably comprises a thermally stable ceramic material.

The molding of a cone is a key process step in the manufacture of glass syringes, for example. Usually, in this case, processes that utilize burners operated with fossil fuels are employed for heating the glass. The usual process flow of this molding comprises several successive heating and shaping steps, with which, starting from glass tube bodies, the desired final geometry is approached. Conventional diameters of the tube glass used lie in the range of 6 to 11 millimeters.

Furthermore, the molding of bottles with conventional diameters of 15 mm-40 mm is fundamentally possible.

Apparatuses in which the forming occurs with burners in several steps are known from DE 10 2005 038 764 B3 and DE 10 2006 034 878 B3, for example. These apparatuses are designed as carousels.

The repeated alternation of heating and glass forming steps is necessary, because the glass blank being formed is cooled by the molds, so that forming in a single forming step has hitherto not been possible. Such processes are often implemented on indexing carousel machines, because such apparatuses are cost-effective to operate and have a space-saving design. For example, carousels with 16 or 32 stations are known. The division of the shaping processes over a number of stations results in a large number of control variables or degrees of freedom, which, for example, must be adjusted by means of manual setting operations for adjusting the overall process. Especially in the case of heat input by means of fossil-fuel burners, however, many degrees of freedom result. In the process, a visual evaluation of the flame and glass condition or of the temperature and its distribution is generally required.

The large number of degrees of freedom or adjustable parameters at the individual stations further makes it possible to perform different process flows by way of different combinations and/or sequences of intermediate steps during glass forming, all of which should lead ultimately to identical results, however. Owing to the large number of adjustable parameters as well as the lack of scaling and/or scalability of the process control, the influence of the equipment operator is of great importance for the quality of the final product, and also for the efficiency of the manufacturing process.

Even when, besides the implementation of shaping on carousel machines, which is already fundamentally relatively cost-effective, additional investment in costly automation functions can be avoided, the production is nonetheless strongly dependent on the availability of experienced and well-trained operating personnel. As a result, there is a significant expense in terms of personnel in regard to the manufacturing costs.

Even in the startup phase of production, laborious fine adjustment of all relevant actuators of the equipment is required. Thus, on carousel machines hitherto used, there are a large number of chucks—for example, 16 or even 32 chucks, for cone forming. Overall, for this purpose and typically including the running-in operation, a period of several hours to several days is required to attain a stable process flow. In addition, readjustments at the large number of stations are generally also required during production.

In addition, so-called running-in phenomena often have a disruptive effect on the processing procedure. These running-in phenomena arise owing, among other things, to thermal expansions due to heating of parts of the equipment by the burners.

Another problem arises owing to the complexity of the process control, as a result of which the temperature cannot be controlled very precisely during forming and thus fluctuations may occur. For this reason, it is often necessary to use specific materials for the molds, which, in connection with certain glasses or in relation to a specific use thereof, can lead to problems.

This relates, in particular, to the forming mandrel, which typically forms a contact zone with said hollow-body-shaped glass product that lies inside of the hollow body during forming. Usually, therefore, forming mandrels comprise materials such as tungsten or rhodium in glass shaping. However, these materials can leave material residues inside of the hollow body, which, during later use in the pharmaceutical field, for example, can lead to adverse interactions with the active substance contained therein.

The invention is thus based on the object of providing an apparatus, a forming process, and a forming mandrel, with which, for at least constant quality of the manufactured glass products, the adjustment effort can be markedly reduced and the production process can be stabilized. In addition, the risk of forming undesired material residues inside of the glass product shaped as a hollow body can largely be reduced or even eliminated entirely.

This object is achieved by the subject of the independent claims. Advantageous enhancements of the invention are presented in the respective dependent claims.

In accordance therewith, the invention relates to a mold for forming glass products shaped as hollow bodies, comprising a forming mandrel, which comprises a thermally stable ceramic material.

Furthermore, the invention provides for an apparatus for forming glass products, comprising
a device for local heating of a region of a primary glass product to above its softening point, and
at least one mold for forming at least one portion of a region of the primary glass product that has been heated with the device for local heating, with the mold comprising a ceramic forming mandrel and with the device for local heating comprising
a laser,
wherein a rotary device is provided in order to rotate the mold and the primary glass product relative to each other, and wherein
the mold is designed such that a surface region of the portion of the primary glass product being formed is not covered by the mold, with the laser or optics downstream of the laser being arranged in such a way that the laser light is irradiated on the region not covered by the mold during forming, and with a control device being provided, which controls the laser so that, at least intermittently, the primary glass product is heated by the laser light during forming.

The mold further comprises a pair of rollers, which is arranged in such a way that the rollers of the pair of rollers roll on the surface of a primary glass product that is set in rotation by means of the rotary device, with a region on the periphery of the primary glass product lying between the rollers being irradiated by the laser light.

In order for heating of the glass of a primary glass product that is being formed in the apparatus to occur, a laser that emits light of a wavelength for which the glass of the primary glass product is at most partly transparent is used, so that the light is absorbed at least partially in the glass.

The process for forming glass products that can be carried out using this apparatus is accordingly based on
heating of a local region of a primary glass product to above its softening point, and
using at least one mold to form at least one portion of a region of the primary glass product that is heated with a device for local heating, with the mold comprising a ceramic forming mandrel or, more generally, a forming mandrel with a ceramic surface, at least in the contact region with the primary glass product, with the device for local heating comprising
a laser, which
emits light of a wavelength for which the glass is at most partly transparent, so that the light is absorbed at least partially in the glass, and which is directed onto the primary glass product,
wherein the mold and the primary glass product are rotated in relation to each other by means of a rotary device, and wherein
the mold is designed such that a surface region of the portion of the primary glass product being formed is not covered by the mold, and wherein
the laser or optics downstream of the laser is (are) arranged in such a way that the laser light is irradiated on the region not covered by the mold during forming, and wherein, by means of a control device, the laser is controlled in such a way that, at least intermittently, the primary glass product is heated by the laser light during forming.

In general, infrared lasers are especially suited as lasers, because the transmission of glasses typically drops from the visible spectral region to the infrared region. Preferably, the wavelength of the laser is chosen such that the glass of the glass object being processed has an absorption coefficient of at least 300 m⁻¹, more preferably at least 500 m⁻¹, at the wavelength. For an absorption coefficient of 300 m⁻¹, about 25% of the laser power is then absorbed on passage through the wall of a glass tube with a wall thickness of 1 mm. For an absorption coefficient of 500 m⁻¹, about 60% of the light is absorbed and can be utilized for heating the glass object.

In general, for forming syringe bodies, lasers with a radiant power of less than 1 kW are adequate in order to ensure sufficiently rapid heating of the glass product. In general, in order to maintain the temperature during forming, even less power is required. Often a radiant power of less than 200 watts is sufficient for this. A preferred range of the irradiated power lies between 30 and 100 watts. However, for forming larger glass objects—for example, for forming glass objects from glass tube with a diameter of 20 millimeters or larger—even greater powers are advantageous under certain circumstances in order to ensure a rapid heating. Mentioned as an example in this connection is the forming of a vial neck for pharmaceutical vials that are manufactured from glass tubes with a diameter of 20 to 30 millimeters.

Accordingly, it is provided in an enhancement of the invention that, in a heating phase prior to the forming process, the laser is operated with a first power and this power is reduced to a second power during the forming process. Preferably, the second power is at least lower than the first power by a factor of four.

Because, in accordance with the invention, thermal energy is continuously supplied during the forced forming of the primary glass product, a cooling during the forming process can be prevented or at least diminished. Preferably, irradiation with the laser radiation occurs prior to the start of forced forming and is continued up to a point in time after the start of the forced forming process.

According to another embodiment of the invention, however, it is also possible not to roll the mold on the primary glass product, but instead to allow it to slide over the glass. In particular, suitable lubricating or parting agents can be used for this purpose. Both embodiments, that is, the embodiment with rolling rollers and the embodiment with a sliding mold can also be used simultaneously or successively. For example, an internal forming of the tip or syringe cone of a syringe body or of the channel may be performed by means of a sliding forming mandrel, while the external forming of the syringe cone is carried out with rolling rollers.

Furthermore, the apparatus and the process according to the invention are preferably employed in order to form primary glass products shaped as hollow bodies, in particular tubular primary glass products. In particular, the mold can be designed in this case for compression, preferably radial compression of a portion of the primary glass product shaped as a hollow body. Such compression is carried out, for example, when the cone of a syringe body is formed from a primary glass product shaped as a hollow body in the configuration of a glass tube.

The invention not only offers the advantage that a cooling of the previously heated primary glass product by the laser radiation during forced forming of the glass can be compensated for. The laser radiation also offers an advantage over the burners used hitherto in that it is possible to make exact and fine adjustments both in time and in location. As a result, in an enhancement of the invention, it is then possible to control or adjust the laser radiation in location and time so that a predefined temperature profile is established along the heated portion of the primary glass product. In order to adjust the laser power in accordance with a desired temperature profile, it is possible, in a simple enhancement of the invention, to provide optics that are upstream of the laser and distribute the laser power onto the primary glass product within the portion of the primary glass product that is to be heated. According to a first embodiment of the invention, such optics may comprise beam-widening optics that widen the laser beam in at least one direction in space. In this way, it is possible to produce a fan-shaped beam from the typically punctiform beam, said fan-shaped beam irradiating an oblong region of the primary glass product.

Another alternative or additional possibility for distributing the laser power consists in moving the laser beam over the portion of the primary glass product that is to be heated or formed. Such a movement may be accomplished with a suitable galvanometer, for example. Also conceivable is a laser with a drive that causes pivoting or translation. In comparison to rigid optics, the movement of the laser beam offers the possibility of adapting the profile of the irradiated laser power prior to and/or during forming. Thus, for example, a spatial intensity distribution of the laser light on the portion being formed that differs from the intensity distribution used for heating may be desirable during forming. Such a difference may be desirable, for example, in order to compensate for spatially inhomogeneous cooling by the mold. Thus, when a syringe cone is formed, it has proven advantageous in one step to apply an asymmetrical distribution of the beam intensity along the axial direction.

This helps to prevent or at least minimize any collapse of the cone into the cylindrical tube of the syringe body. When fossil fuel burners are used, by contrast, typically a symmetrical, large-area heating is brought about, as a result of which regions of the cylindrical tube are also heated and thus softened, thereby enabling collapse of the cone in the axial direction into the cylindrical part of the syringe body.

In general, it is appropriate to distribute the laser power in the direction along the axis of rotation. The rotational movement then results in a uniform distribution of the thermal energy over the periphery of the portion of the primary glass product being heated, while a specific temperature profile can be adjusted along the axial direction.

Owing to the precise and reproducible temperature control of the forming process, typical restrictions that ensue from the choice of a forming mandrel or from the choice of a material for the forming mandrel, in particular, are eliminated. Whereas, owing to imprecise temperature control in the region of the forming process as well as to an often too imprecise positioning of the chuck on the carousel machine and a thereby resulting detrimental load placed on the forming mandrel during forming, forming mandrels based on ceramic materials were hitherto unsuitable, it is now possible to use such materials for forming mandrels owing to the process according to the invention.

### [Start]

An apparatus and a forming process in terms of the invention enable the production process to be improved and stabilized to such an extent that, surprisingly, such ceramic materials can be used for the forming mandrel, even though, as brittle materials, they exhibit only low fracture toughness.

As a result, diverse advantages ensue. Accordingly, it is possible to dispense largely or entirely with the use of materials such as tungsten or rhodium for forming mandrels, particularly in the contact regions between the forming mandrel and the glass product. Such materials may lead to residues, particularly in the regions of contact with the glass product.

Thus, the use of forming mandrels made of tungsten may lead to residues in the cone channel of the glass product, which can then lead to undesirable reactions during later intended use of the glass product formed. For example, when such formed glass products are filled with a pharmaceutical active substance, an interaction, such as degradation, may occur between the active substance and the material residue on the glass surface. This is especially detrimental when the glass products are to be filled with sensitive pharmaceutical or biopharmaceutical products.

In this case, the forming mandrel is made of a thermally stable ceramic material, at least in the area that, during forming, is in contact with the glass object being formed. In other words, the forming mandrel preferably comprises at least one thermally stable ceramic material or one industrial ceramic in the region that forms the contact surface to the glass product.

The term thermally stable is understood in terms of the invention to mean that the forming mandrel has a higher softening temperature than the glass product being formed and hence has sufficient strength and hardness for forming during forming of the glass product.

In the process, the forming mandrel may also be produced entirely from a thermally stable ceramic material or an industrial ceramic. Such materials may comprise oxide and/or non-oxide ceramics and/or composite materials based on these and/or metal-ceramic composite materials. Thus, it is also possible to use, for example, metallic base bodies that are coated with ceramic materials.

More preferably, the forming mandrel may comprise thermally stable ceramic materials based on aluminum oxide, zirconium oxide, aluminum titanate, silicate ceramics, silicon carbide, silicon nitride, or aluminum nitride. Such materials are often sufficiently thermally stable, particularly in the region of the glass transition temperature T_{G} of the glass being formed and even beyond it. In terms of the invention, the material of the forming mandrel may be chosen in accordance with the glass transition temperature of the glass being formed, so that the temperature at which the industrial ceramic of the forming mandrel is used lies advantageously above the glass transition temperature of the glass product.

Quite more preferably, the forming mandrel is largely or entirely free of materials such as tungsten and rhodium in those regions that come into contact with the glass object being formed. Thus, the proportion of tungsten and/or rhodium in the contact region of the forming mandrel is preferably less than 0.5 wt %, more preferably less than 0.1 wt %.

Various advantages ensue from this. Thus, on the one hand, the risk of undesired residues on parts of the surface of the formed glass product, in particular in an inner-lying cone region, can be largely prevented or even fully excluded. As a result, when the glass product is later used further as, for example, a receptacle for sensitive pharmaceutical or biopharmaceutical active substances, any undesired interaction of material residues with the active substance is largely excluded. Thus, for instance, any degradation of the active substance can be reduced or even fully suppressed.

Thus, ceramic materials that are largely harmless with respect to interactions with later contents of the receptacle can be used, particularly in the region of contact with the glass product.

When such materials are used for the forming mandrel, it is possible, on the one hand, to reduce undesired material residues overall. On the other hand, the possibly still formed residues are harmless with respect to possible interactions with the substances later contained in the receptacle.

Furthermore, the very exact temperature control in the forming region enables a sufficiently high temperature for the forming of the glass product to be attained, without, on the other hand, too high a temperature in the contact zone between the glass product and the forming mandrel leading to adhesions because the adhesion temperature is exceeded. In this way, it is also possible to use a brittle material, such as an industrial ceramic, as material for the forming mandrel, without resulting in increased damage to the forming mandrel or defects on the glass body.

The invention further also makes possible a completely different design of forming apparatuses, such as those employed for the fabrication of syringe bodies. As already discussed above, carousels with 16 to 32 stations have been hitherto employed for this purpose. The shaping process proceeds station by station, with the ultimate form being attained in several steps through the successive use of molds. Heating occurs in between the forming steps in order to compensate for the drop in temperature during forming. Because, in accordance with the invention, the heating takes place during forming and thus any drop in temperature can be compensated for, the entire hot forming of a portion being formed can be carried out in a single station in accordance with the invention. In other words, all molds used for forming the portion are used in one forming station, with the laser beam heating the primary glass product during forming in this case or else keeping it at the intended temperature.

Hence, according to this embodiment of the invention, the apparatus has at least one forming station, with all molds being present at the forming station, in order to carry out all hot forming steps at one portion of the primary glass product for manufacture of the final product.

Such a design of the forming station is quite especially suited for the use of forming mandrels based on thermally stable ceramic materials, because the lateral loads on the forming mandrel during forming can be markedly reduced in comparison to carousel machines. Thus, in the case of carousel machines, a different positioning of the various chucks in the machine can lead to high lateral loads on the forming mandrel, which can exceed the fracture toughness of ceramic materials. By contrast, in the case of said forming station, both the temperature control in the forming region of the glass product and the positioning accuracy of the forming mandrel can be improved so that even brittle ceramic materials can be used for the forming mandrel.

Owing to the possibility of positioning the forming mandrel in the forming station very precisely and exactly by means of the chuck as well as also the outer molds, in particular the forming rollers, it is possible to align the molds in relation to one another with very high reproducibility. As a result, loads due to lateral forces that act non-symmetrically on the forming mandrel can be largely prevented. In this way, it is possible to minimize the lateral load on the forming mandrel during the forming process to such an extent that the fracture stress of the ceramic material is not reached.

By means of the high-precision laser heating, it is also possible to maintain a very small temperature process window for forming with high reproducibility. In the process, the lower limit of the process window typically results from the glass transition temperature T_{G} and the upper limit results from the avoidance of any adhesion between the material of the forming mandrel and the glass during forming.

It is known that a mold that is too hot can lead to a brief adhesion of the glass to the mold. Prolonged adhesion is often also referred to as sticking. The sticking or else adhesion temperature can be influenced by the viscosity of the glass, the thermal conductivity of the glass, and its density as well as by the material of the forming mandrel, in particular in the contact region. Regarding the material of the forming mandrel, the penetration of heat is of great importance.

Any adhesion and/or sticking can lead to increased mold wear and to glass product reject and is therefore to be avoided if at all possible.

The use of a forming mandrel containing a ceramic material in the region of contact with the glass can lead to a small process window in regard to the forming temperature, because the critical adhesion or sticking temperature can be reached relatively early on. In other words, the temperature that has to be attained in order to be able to form the glass accordingly and the temperature at which adhesion or sticking takes place may lie very close to each other.

Therefore, in the choice of the ceramic material for the forming mandrel, preferably attention is to be paid to the attainment of a certain heat penetration index of the ceramic material. The inventors have found that, advantageously, materials with a heat penetration index at or above about b=60 W*s^{1/2}/m²*K are especially suitable for the forming mandrel in order to make possible a sufficiently large temperature process window. The especially preferred ceramic materials for the forming mandrel are therefore aluminum oxide, silicon nitride, and/or silicon carbide.

In an especially preferred enhancement of the invention, the forming mandrel comprises a ceramic layer, at least in the area that forms a region of contact with the glass product during the forming process. For further increase in the mechanical stability, the forming mandrel can therefore include a metal core with a ceramic layer, with this ceramic layer being based more preferably on the materials aluminum oxide, silicon nitride, and/or silicon carbide.

Hence, the general design of the invention is based on this special embodiment, in which, though the use of a laser, the partial steps of the conventional forming are integrated into a few steps and ideally into one step. This is made possible, because, during forming, the laser enables energy to be input into the glass in a defined variable manner and in a reproducible manner owing to the ready control of the power and its distribution in location and time.

In enhancement of this embodiment of the invention, it is then possible once again, similarly to the apparatuses known from prior art, to employ a plurality of stations, with the stations carrying out similar forming steps in accordance with this enhancement of the invention. In this way, the parallel, similar forming enables the throughput of such an apparatus to be increased substantially in comparison to known apparatuses.

Even in the case of a single station, this results generally in a substantial advantage in terms of speed in comparison to an apparatus with 16 or 32 stations of conventional design. In the case of a conventional apparatus, the required time for a forming step is typically on the order of 2 seconds. If 4 forming steps are assumed and the times for five to six intervening heating steps with burners are additionally taken into consideration, then the total duration of the forming is about 20 seconds. By contrast, the invention enables the forming time to be limited to the duration of one or a few conventional forming steps. As a result, the forming process can readily be accelerated substantially. Thus, the time for forming a portion of the primary glass product, calculated without the duration of heating, is preferably less than 15 seconds, more preferably less than 10 seconds, particularly preferably less than 5 seconds.

Furthermore, it is of advantage to adapt the laser power in the course of the process. In particular, the irradiated laser power during the forming process can be reduced in comparison to the laser power in a heating phase preceding the forming.

According to yet another enhancement of the invention, the laser power can be regulated by means of a control process implemented in the control device also on the basis of a temperature measured by a temperature measurement device prior to and/or during forming in order to adjust a predetermined temperature or a predetermined temperature/time profile at the primary glass product. Especially a contactless measuring device, such as, for instance, a pyrometer, is suitable as a temperature measurement device in this case. Such a regulation enables the temperature of the glass to be stabilized within a process window of less than ±20° C., in general even at most ±10° C.

The invention will be explained below in detail on the basis of exemplary embodiments and with reference to the appended figures. Here, identical reference signs in the figures identify identical or corresponding elements. Shown are:

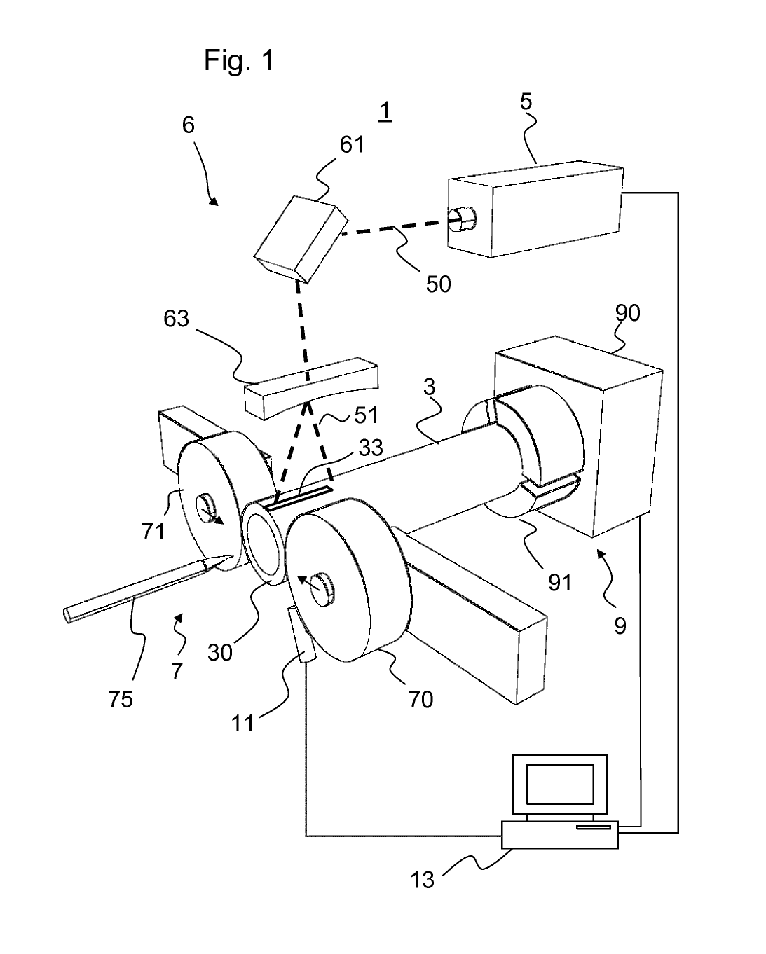

FIG. 1, parts of an apparatus for forming of a glass tube,

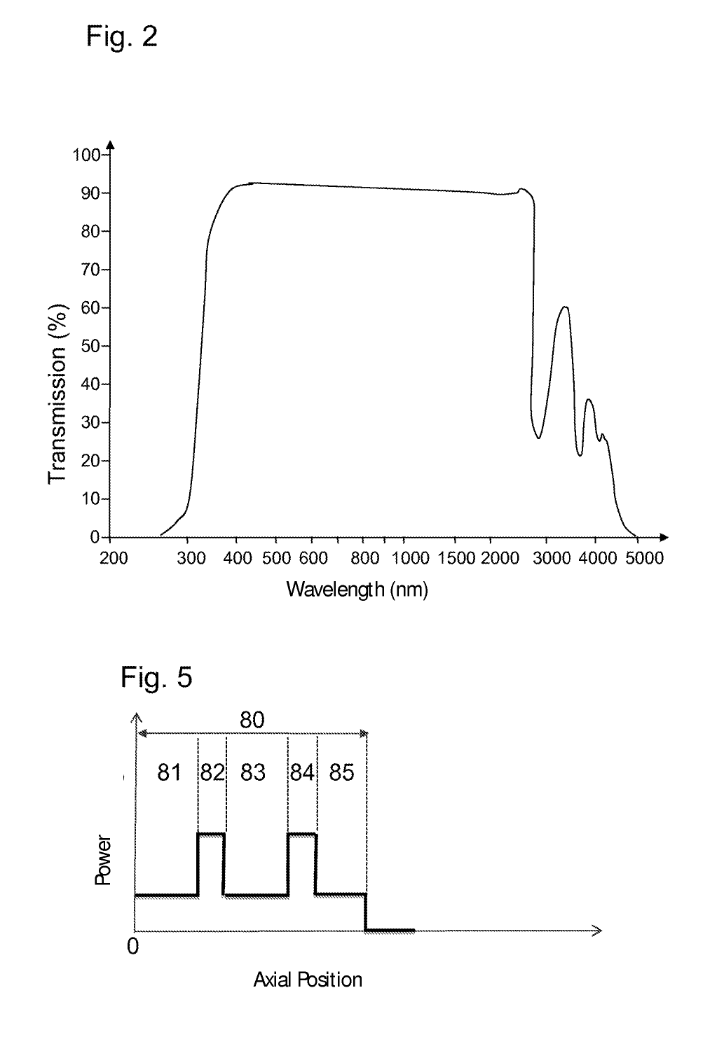

FIG. 2, a transmission spectrum of a glass of a primary glass product,

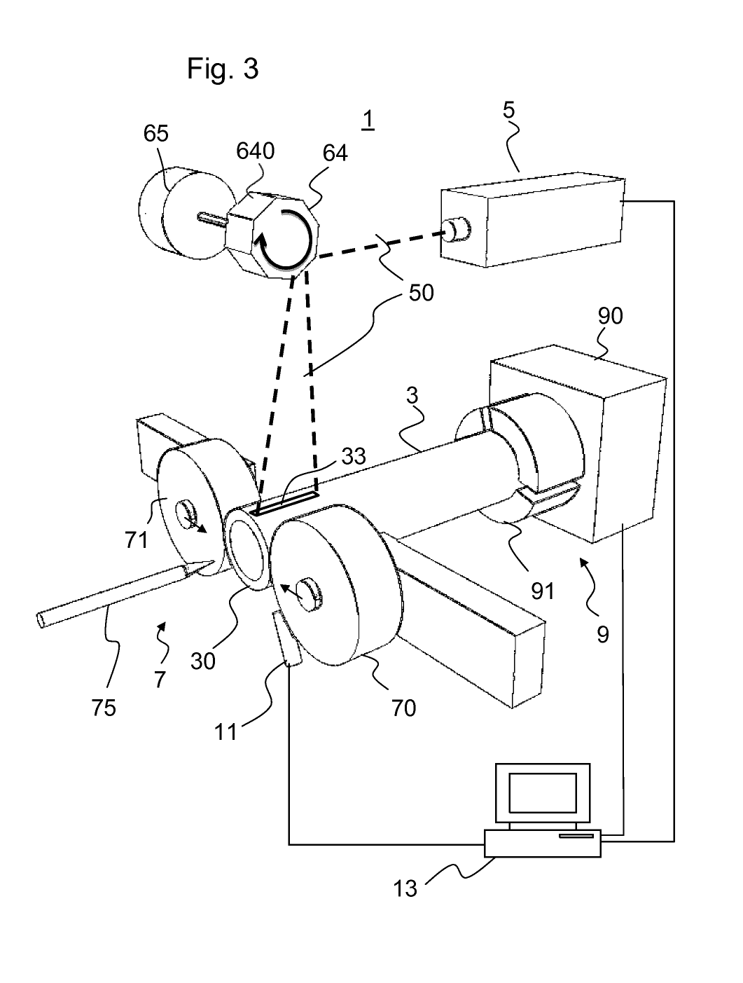

FIG. 3, a variant of the exemplary embodiment shown in FIG. 1,

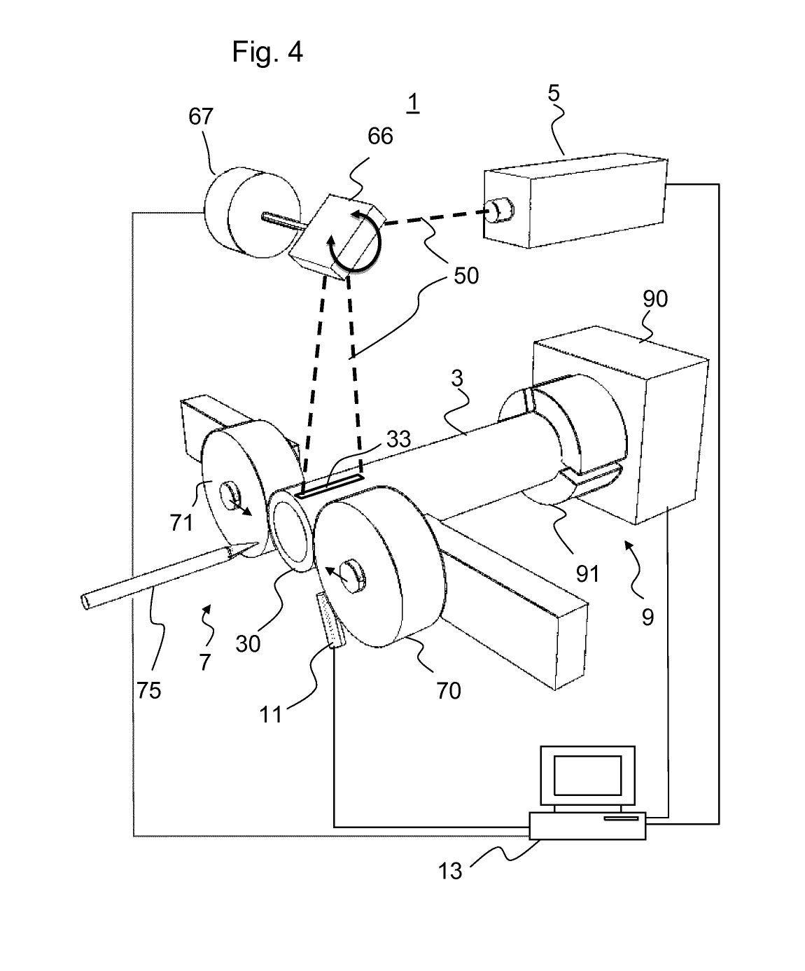

FIG. 4, another variant,

FIG. 5, a schematic diagram of the irradiated laser power as a function of the axial position along a primary glass product,

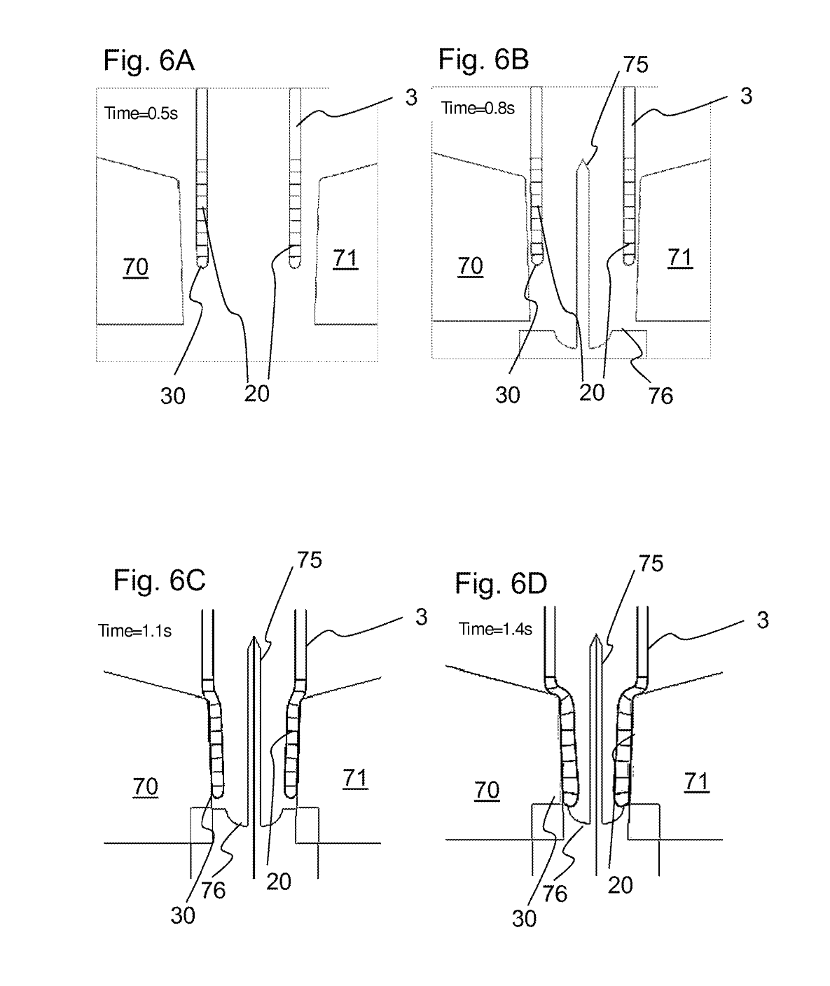

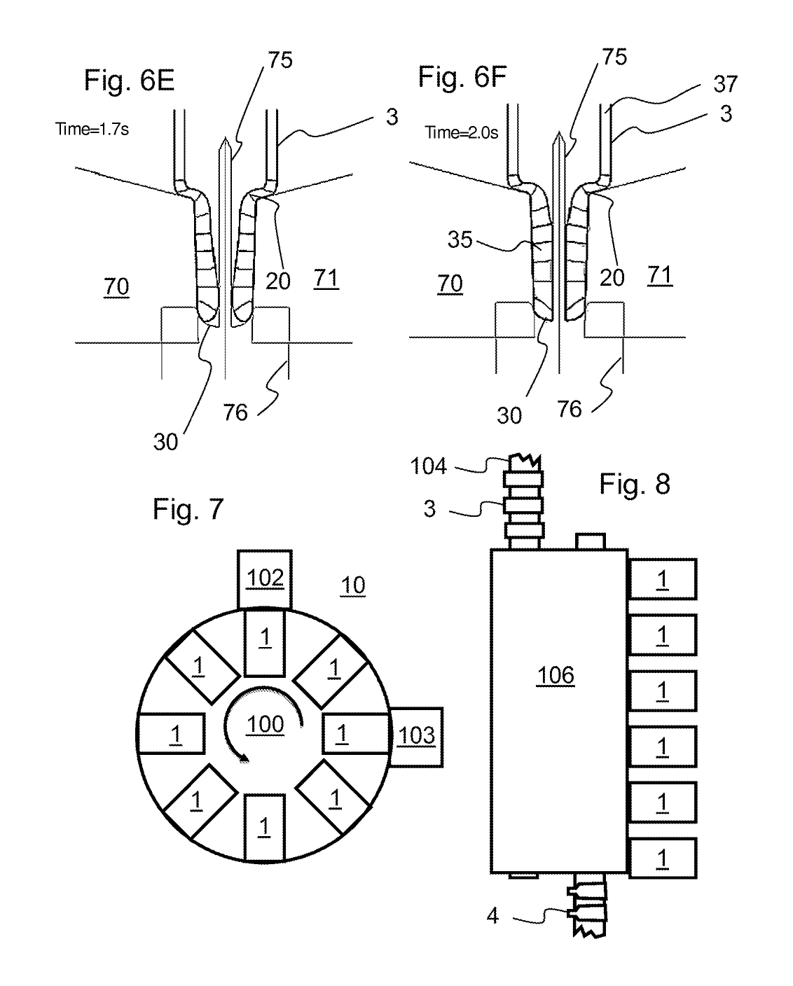

FIG. 6A to 6F, sectional views through a glass tube in the course of the forming process,

FIG. 7, a forming unit with a plurality of apparatuses for forming of a glass tube,

FIG. 8, a variant of the forming unit shown in FIG. 7, and

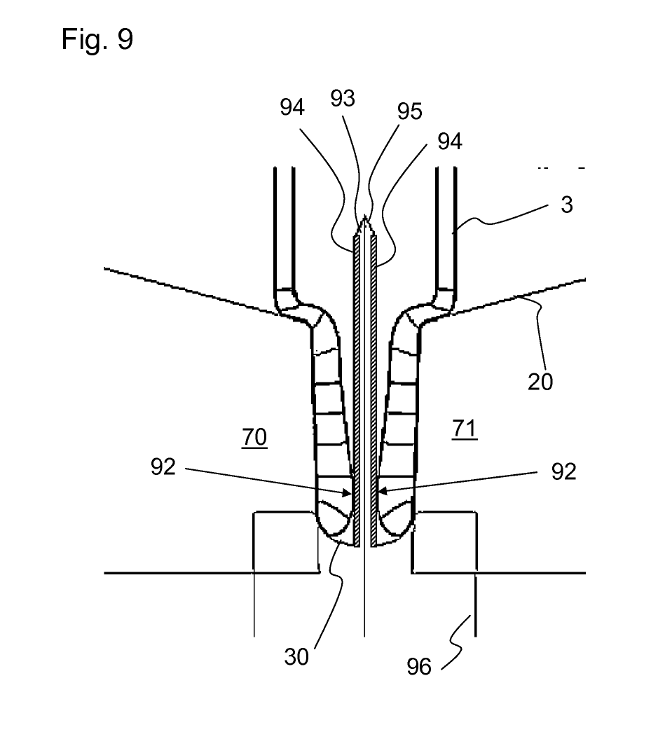

FIG. 9, a sectional view through a glass tube in the course of the forming process using a forming mandrel, which, in the region that forms the contact surface to the primary glass product, comprises at least one thermally stable ceramic material.

Illustrated in FIG. 1 is an exemplary embodiment of an apparatus 1 for carrying out the process according to the invention.

The apparatus of the exemplary embodiment shown in FIG. 1, which is identified overall with the reference sign 1, is designed for forming primary glass products in the form of glass tubes 3. In particular, the apparatus is used for the manufacture of glass syringe bodies, with the cone of the syringe body being formed from the glass tube by using the elements of the apparatus 1 that are shown in FIG. 1.

The manufacture of the cone from the glass tube by means of the apparatus 1 is based on local heating of a region of the glass tube 3—in this case, its end 30—to above its softening point and forming at least one portion of the heated end by using at least one mold, with the device for local heating comprising a laser 5 that emits light of a wavelength for which the glass of the glass tube 3 is at most partly transparent, so that the light is absorbed at least partially in the glass. For this purpose, the laser beam 50 is directed onto the glass tube 3 by means of the optics 6. During the forming process, the mold 7 and the primary glass product 3 are rotated in relation to each other by means of a rotary device 9. In general, it is appropriate in this case, as also in the example shown, to rotate the glass tube 3 with the axis of rotation along the axial direction of the glass tube 3. For this purpose, the rotary device 9 comprises a drive 90 with a chuck 91, with which the glass tube 3 is held. Also conceivable would be the reverse configuration in which the glass tube is firmly held and the mold 7 rotates around the glass tube.

In the exemplary embodiment shown in FIG. 1, the mold 7 comprises two rollers 70, 71, which, when rotating, roll on the surface of the glass tube 3. In this case, the end 30 of the glass tube 30 is compressed by approach of the rollers toward each other in the radial direction of the glass tube 3. The radial movement is indicated in FIG. 1 by arrows at the axes of rotation of the rollers 70, 71. A forming mandrel 75 is further provided as a component of the mold 7. This forming mandrel 75 is inserted into the opening of the glass tube 3 at its end 30 being formed. The cone channel of the syringe body is formed by means of the forming mandrel 75. The forming mandrel 75 can be mounted so as to turn in order to rotate together with the glass tube 3. It is equally possible for the rotating glass to be allowed to slide over the firmly held mandrel.

For this purpose, in order to prevent any adhesion, as observed in general in the case of molds that slide over the glass surface, a parting or lubricating agent is used, which diminishes the friction during the sliding movement. It is further possible to use a lubricating agent that vaporizes at the temperatures employed during forming. When such a lubricating agent is used, it is advantageously possible to prevent lubricating agent or parting agent residues on the finished glass product.

It is possible to direct the laser beam 50 between the rollers 70, 71 onto the glass tube, without interruption of the laser beam 50 by the mold. Accordingly, the mold is designed such that a surface region of the portion of the glass tube being formed is not covered by the mold, so that, by means of the optics 6 downstream of the laser, the laser light is irradiated onto the region not covered by the mold during forming. In particular, a region 33 on the periphery of the glass tube 3, lying between the rollers 70, 71, is irradiated by the laser light.

A control device 13 controls the forming operation. In particular, the laser 5 is actuated by means of the control device 13 in such a way that the glass tube 3 is heated at least intermittently by the laser light during forming.

The optics 6 of the apparatus shown in FIG. 1 comprise a deflecting mirror 61 as well as a cylindrical lens 63.

The laser beam 50 is widened to a fanned beam 51 along the axial direction of the glass tube 3 by means of the cylindrical lens 63, so that the region 33 illuminated by the laser light is correspondingly expanded in the axial direction of the glass tube 3. Because the glass tube 3 rotates during irradiation with the laser light, the irradiated power is distributed in the peripheral direction on the glass tube, so that a cylindrical portion or, in general, a portion in the axial direction along the axis of rotation, is heated, regardless of the shape of the primary glass product. This portion has a length that is preferably at least as large as the portion being formed. The latter has a length that is determined essentially by the width of the rollers. In order to achieve special distributions of the laser power in the axial direction of the glass tube, it is possible, alternatively or additionally, also to use advantageously a diffractive optical element in addition to the cylindrical lens 63.

The forming process is controlled by means of the control device 13. Among other things, the control device 13 controls the laser power. Furthermore, the movement of the molds 70, 71, 75 is also controlled. The rotary device 9 can likewise be controlled as well, in particular the speed of rotation of the drive 90 and, if need be, also the opening and closing of the chuck 91.

When syringe bodies are formed from glass, generally radiant powers of less than 1 kilowatt are sufficient for the laser 5 in order to ensure rapid heating to the softening temperature. Once the predetermined temperature for hot forming is reached, the laser power can then be down-regulated by the control device 1, so that the irradiated laser power still compensates for the cooling only. For this purpose, in the manufacture of syringe bodies, powers of between 30 and 100 watts are generally sufficient.

The regulation of the laser power can be accomplished, in particular, also on the basis of the temperature of the glass tube 3. For this purpose, a control process can be implemented in the control device 13, which regulates the laser power on the basis of the temperature measured by means of a temperature measurement device in order to adjust a predetermined temperature or a predetermined temperature/time profile at the primary glass product. Provided as a temperature measurement device in the example shown in FIG. 1 is a pyrometer 11, which measures the thermal radiation of the glass tube at the end 31 that is heated by the laser 5 and uses it in the control process to adjust the desired temperature.

It is especially advantageous in an arrangement according to the invention, such as that shown in FIG. 1 by way of example, when the laser light does not directly heat the molds. The result of this is that the molds are generally not heated more strongly than in a conventional process with preceding heating by burners, in spite of a heating of the primary glass product during forming. Overall, less thermal energy is produced by the apparatus according to the invention and this thermal energy is also introduced into the primary glass product in a more specific manner. As a result, the heating of the entire apparatus and thus, among other things, running-in phenomena arising from thermal expansions are overall reduced.

A preferred glass for the fabrication of syringe bodies is borosilicate glass. Especially preferred in this case is low-alkali borosilicate glass, in particular with an alkali content of less than 10 weight percent. Borosilicate glass is generally well suited owing to its typically high stability to changes in temperature. This is advantageous so as to be able to create rapid heating ramps in the case of short process times, such as those that can be achieved with the invention.

A suitable low-alkali borosilicate glass has the following components in weight percent:

### SiO₂ 75 wt

### B₂O₃ 10.5 wt %

### Al₂O₃ 5 wt %

### Na₂O 7 wt %

### CaO 1.5 wt %

FIG. 2 shows a transmission spectrum of the glass. The transmission values are given in relation to a glass thickness of one millimeter.

It can be seen on the basis of FIG. 2 that the transmission of the glass drops at wavelengths above 2.5 micrometers. Above 5 micrometers, the glass is practically opaque even for very thin glass thicknesses.

The decrease in the transmission in the wavelength region above 2.5 micrometers, shown in FIG. 2, is not largely dependent on the exact composition of the glass. Thus, given similar transmission properties, the contents of the constituents of preferred borosilicate glasses given above can also vary by 25% from the given value in each case. Furthermore, besides borosilicate glass, it is obvious possible to employ other glasses, provided that they are at most partly transparent at the wavelength of the laser.

FIG. 3 shows a variant of the apparatus shown in FIG. 1. Here, too, as for the example shown in FIG. 1, optics 6 are provided, which are upstream of the laser 5 and distribute the laser power on the primary glass product within the portion of the primary glass product being heated—in this case, once again the end 30 of the glass tube 3. However, instead of beam-widening optics 6 according to the example shown in FIG. 1, movement occurs in the axial direction, so as to achieve special distribution of the radiant power of the laser beam 50 over the portion of the primary glass product being heating or formed, that is, along the axis of rotation. For this purpose, the optics 6 comprise a ring mirror or a rotating mirror 64 with mirror facets 640. The rotating mirror 64 is driven by a motor 65 and is set into rotation. The axis of rotation of the rotating mirror 64 is traverse to the normals of the mirror facets—in particular, perpendicular thereto in the example shown in FIG. 3. Furthermore, the axis of rotation also is traverse, preferably perpendicular to the axial direction or to the axis of rotation of the glass tube 3. As a result of the rotation of the normals of the mirror facets 640, the laser beam 50 is moved in the axial direction along the glass tube 3 in this way, depending on the varying angle of the respectively irradiated mirror facet 640, so that, on time average, the laser beam 50 irradiates a region 33 on the glass tube or a correspondingly long axial segment of the glass tube 3.

FIG. 4 shows another variant of the apparatus shown in FIG. 1. Just like the variant shown in FIG. 3, the laser beam 50 is scanned over a region 33 so as to distribute the radiant power along the axial segment of the glass tube 3 being heated. For this purpose, in this case, the deflecting mirror is replaced by a pivoting mirror 66, the pivot axis of which is traverse and preferably perpendicular to the axis of rotation of the glass tube 3. The pivoting mirror 66 is pivoted by means of a galvanometer drive 65, so that the position of impingement of the laser beam 50 is moved in correspondence to the pivoting of the glass tube 3 in the axial direction.

An advantage of this arrangement is that the galvanometer drive can be controlled by the control device 13, so that, by way of correspondingly faster and slower pivoting movements, differently long illumination times allow specific location-dependent power distributions to be accomplished in a simple manner, depending on the pivot angle or on the axial position of the point of impingement. In enhancement of the invention, therefore, without limitation to the special example shown in FIG. 4, optics that have a beam-deflecting device actuated by the control device are provided, so that, through corresponding actuation of the beam-deflecting device by the control device, it is possible to adjust a predetermined profile in terms of location and power. Such a profile then also enables any desired location-dependent temperature distribution to be created.

Both the embodiment shown in FIG. 3 and that shown in FIG. 4 make possible another, alternative or additional control in order to enable predetermined local distributions of the radiant power introduced into the glass. For this purpose, a beam-deflecting device is once again provided. In order to vary the irradiated power as a function of location, the power of the laser can then be regulated depending on the beam deflection by the control device. If, for example, a first axial subsegment of the heated axial segment is to be heated more strongly or more weakly than an adjacent second subsegment, the laser power is correspondingly up-regulated or down-regulated by the control device when the laser beam sweeps the first subsegment.

If the angle of rotation of the rotating mirror or that of its respectively illuminated mirror facet 640 in the example of the control device shown in FIG. 3 is known, the control device 13 can correspondingly adjust the power of the laser 5.

For purpose of highlighting, FIG. 5 shows a conceivable distribution of the laser power on the primary glass product. Illustrated is a diagram of the laser power as a function of the axial position of the point of impingement of the laser beam on the primary glass product. In this case, the position “0” marks the end of the primary glass product. As can be seen on the basis of the diagram, the entire heated axial segment 80 in this example is divided into the subsegments 81, 82, 83, 84, and 85. In this case, the subsegments 82 and 84 are irradiated with higher power of the laser than are the adjacent subsegments 81, 83, and 85. As described above, the higher radiant power introduced into the subsegments 82, 84 can occur by regulation of the laser power as a function of the position of the beam-deflecting device, that is, in the examples shown in FIGS. 2 and 3, as a function of the angle of rotation or pivot angle of the mirror. Alternatively or additionally, it is possible, also as described above, to vary the pivoting or rotational speed of the mirror, so that, in this case, the axial subsegments 82, 84 are irradiated overall for a longer period of time.

Such an inhomogeneous deposition of the laser power in the axial direction, as illustrated in FIG. 5 by way of example, can be of advantage in a number of respects. If, for example, a homogeneous temperature distribution during the forming process is being sought, whereas an inhomogeneous dissipation of heat occurs, the inhomogeneity of the thermal losses can be compensated for at least in part by an adjustment of a corresponding profile of the irradiated power. For example, subsegments of the primary glass product that come into contact initially or for longer periods of time with the mold are heated correspondingly more strongly via the laser beam in order to compensate for the thermal losses additionally occurring at the mold. On the other hand, it may also be advantageous especially to seek an inhomogeneous temperature profile in the axial direction. Such a temperature profile can be advantageous in order to control additionally the material flow occurring during forming. Typically, taking into consideration the pressure or pull exerted by the mold, the glass tends to flow from warmer and thus softer regions to colder and thus more viscous regions in the primary glass product. An advantageous possibility is, for instance, to reduce any decrease in the wall thickness of the glass tube that occurs in regions in which the mold [causes] a strong deformation, in particular when there is stretching or bending of the glass material.

It may likewise be very advantageous to induce an enhanced material flow when there is an increase in the wall thickness owing to radial compression of a glass tube.

These effects are explained below on the basis of FIG. 6A to 6F. These figures show, on the basis of sectional views, a simulation of a forming process according to the invention for forming a syringe cone from a glass tube 3 for the manufacture of a syringe body. The sections of the illustrations run along the central axis of the glass tube 3, around which the glass tube is rotated. Also seen are the rollers 70, 71 and the mandrel 75. Once again, the laser beam irradiation occurs between the rollers, so that the direction of irradiation is perpendicular to the illustrated sectional planes.

Also given in each case is the time elapsed since the start of the forming process. The time point of reduction of the laser power is chosen as the zero null point for the forming process.

The lines 20, which are drawn in the sectional views of the glass tube and initially are perpendicular to the central axis of the glass tube, mark imaginary boundary lines of axial segments of the glass tube 3. The material flow during forming is highlighted by these lines.

The forming mandrel 75 protrudes from a foot 76, which serves for forming the front conical surface of the syringe. The foot 76 is a component with a flat design that is perpendicular to the direction of view of FIG. 6A to 6F. In the actual apparatus, in contrast to the illustration, the foot is turned by 90° around the longitudinal axis of the forming mandrel 75 in this case, so that the foot 76 fits between the rollers 70, 71. Therefore, the overlap of the rollers 70, 71 and the foot 76, as can be seen from FIG. 6C on, does not occur in actuality.

Contact of the rollers 70, 71 and the onset of deformation occurs starting at the position shown in FIG. 6C. There then occurs a compression of the glass tube 3 by the rollers 70, 71, which move radially inward toward the central axis of the glass tube. At the stage shown in FIG. 6E, the forming mandrel 75 contacts the glass tube on its inside and forms the channel of the syringe cone. Finally, at the stage shown in FIG. 6F, the forming of the syringe cone is already concluded. Afterward, the mold is retracted from the formed syringe cone 35. All forming steps for forming the syringe cone 35 were thus carried out with the same molds 70, 71, 75 and the foot 76. Such a forming station therefore carries out all hot forming steps on a portion of the primary glass product. Forming of the syringe flange or the finger rest at the other end of the glass tube can then occur.

From the forming stage on, as illustrated in FIG. 6E, it can readily be seen that the radial compression at the syringe cone 35 leads to an increase in the wall thickness. In this case, there is now the possibility of producing a certain material flow away from the end 30 by adjusting a corresponding temperature distribution, as described above. A reduction in the wall thickness can also occur at the peripheral edges of the formed glass tube in the transition region between the syringe cylinder 37 and the syringe cone 35. This effect can also be countered by adjusting an axial inhomogeneous input of power via regulation of the axial distribution of the laser power.

In general, it is thus possible, with the temperature control enabled by the laser, to influence the direction of glass flow. In particular, this is also possible with respect to the volume proportion and the direction of the glass flow.

On the basis of FIG. 6A to 6F, it is further clear that the totality of forming steps at a portion of the primary glass product—in this case, particularly a syringe cone—can be completed within a few seconds. The entire forming time in the example of FIG. 6A to 6F amounts to even less than two seconds.

The use of forming mandrels 75, comprising thermally stable ceramic materials or just those with thermally stable ceramic materials in the region of contact with the primary glass product affords still more advantages, in particular in regard to the manufacture of pharmaceutical packaging, such as syringes, carpules, ampoules, vials, etc. Owing to the frequent use of tungsten-containing materials hitherto, in particular also in the region of contact with the primary glass product, tungsten deposits can form, said tungsten deposits arising owing to abrasion of the molds, particularly of the forming mandrel. The invention is therefore especially suited for tungsten-free or low-tungsten pharmaceutical packaging, such as, in particular, syringes, because, owing to the use of harmless ceramic materials in the contact region, any contamination by the molds is reduced. Also, in general, the molds are heated less by the process according to the invention and this also reduces any contamination.

Another advantage of the relatively very short processing time lies in reduced alkali leaching when alkali-containing glasses are processed. When the glasses are heated above the softening point, diffusion of alkali ions to the surface generally occurs. This effect can be detrimental especially in the case of pharmaceutical packaging, because various pharmaceuticals are sensitive to alkali metals. Because the forming time by means of the apparatus according to the invention is substantially shorter than in the case of conventional forming using burners preceding the individual forming stations, the alkali accumulation at the surface is also markedly reduced. Finally, the use of burners can also lead to the introduction of combustion residues and fine dust.

On the basis of the effects described above, it is clear that a glass product manufactured with the invention can differ from glass products hitherto formed using burners in terms of chemical features at the glass surface.

FIG. 7 shows schematically an exemplary embodiment of a forming unit 10 with a plurality of forming stations in the form of the apparatus 1 described above. In contrast to the apparatuses known in the prior art mentioned above, in which the primary glass products are formed successively in a large number of forming stations in a plurality of steps, the basis of the concept of the embodiment shown in FIG. 7 is that the glass tube portions remain in one forming station or in the apparatus 1 during the entire forming process for a portion of the glass tube, such as, for example, the forming of the syringe cone.

In this exemplary embodiment, the forming unit 10 has a carousel 100, similar to the units for the manufacture of glass syringes that are known from prior art. Installed on the carousel 100 are a plurality of apparatuses 1—for example, as illustrated, eight—for forming glass products. At one input station 102, the apparatuses 1 are loaded with primary glass products, such as, in particular, glass tube portions. While the loaded apparatuses 1 now rotate on the carousel 100 to a removal station 103, the forming, such as, for instance, the forming of syringe cones described on the basis of FIG. 1, 3, 4, 6A-6F, is carried out in the apparatuses 1 on the primary glass products. In contrast to the known forming units with carousels, the molds in this case can also be arranged on the carousel itself. Also conceivable is a design of the forming unit in which the forming stations 1 are stationary and are loaded and unloaded in parallel. FIG. 8 shows such a variant. The glass tubes 3 are fed via a feed device 104—for example, a conveyor belt of a loading and unloading device 106.

Said feed device distributes the glass tubes 3 on the apparatuses 1, in which the laser-assisted forming of the syringe cones occurs. After being formed, the intermediate or end products are fed in the form of glass tubes 4 with formed syringe cone from the loading and unloading device 106 to a discharge device 107, which transports away the formed glass tubes 4.

Finally, FIG. 9 shows a sectional view through a glass tube in the course of the forming process using a forming mandrel 95 according to the invention. The forming mandrel 95 protrudes from a foot 96, which serves for forming the front conical surface of the syringe. The foot 96 is a component with a flat design that is perpendicular to the direction of view of FIG. 9. In the actual apparatus, in contrast to the illustration, the foot is turned by 90° around the longitudinal axis of the forming mandrel 95 in this case, so that the foot 96 fits between the rollers 70, 71.

The depicted forming mandrel 95 comprises a metal core 93. The forming mandrel 95 further comprises at least one thermally stable ceramic material 94 in the region of the contact surface 92 to the glass tube 3. The thermally table, ceramic material can be applied, for example, in the form of a surrounding layer onto the metal core of the forming mandrel 95. The layer can be applied, for example, by means of thermal spraying methods. Furthermore, the foot 96 can also be formed with a thermally stable ceramic material (not illustrated) in the region of the contact surface with the glass tube 3. The forming mandrel 95 can also be formed in its entirety from a thermally stable ceramic material.

It is obvious to the person skilled in the art that the invention is not limited to the merely exemplary embodiments described above on the basis of the figures, but can be varied in diverse ways within the scope of the subject of the patent claims. In particular, the features of individual exemplary embodiments can also be combined with one another.

Thus, the invention was described in the figures on the basis of forming the syringe cone of a glass syringe body. However, the invention is applicable in a corresponding way not only to the forming of the finger rest of syringe bodies, but also to the forming of other primary glass products. In particular, the invention is generally suited for the manufacture of pharmaceutical packaging made of glass. Included here, besides syringes, are also carpules, vials, and ampoules. Furthermore, the use of the laser as heating device is not exclusive. Instead, other heating devices are also employed as well. Thus, it is possible and, owing to the high heating power, even advantageous under circumstances, to carry out preheating using a burner in order to reduce the initial duration of heating prior to the forming process.

### LIST OF REFERENCE SIGNS

1 apparatus for forming glass products
3 glass tube
4 glass tube with formed syringe cone
5 laser
6 optics
7 mold
9 rotary device
10 forming unit
11 pyrometer
13 control device
20 imaginary boundary line of axial segments of a glass tube 3
30 end of 3 being formed
33 illuminated region of 3
35 cone
37 syringe cylinder
50 laser beam
51 fanned beam
61 deflecting mirror
63 cylindrical lens
64 ring mirror
65 motor for 64
66 pivoting mirror
67 galvanometer drive
70, 71 rollers
75 forming mandrel
76 foot of 75
80 heated axial segment of 3
81-85 subsegments of 80
90 drive of 9
91 chuck
92 contact surface
93 metal core
94 ceramic material
95 forming mandrel with metal core
96 foot of 95
100 carousel
102 input station
103 removal station
104 feed device
106 loading and unloading device

1-19. (canceled)

20. An apparatus for forming glass products, comprising:
a device for local heating of a region of a primary glass product to above its softening point, the device for local heating comprising a laser;
at least one mold for forming at least one portion of the region, the at least one mold comprises a forming mandrel for forming the primary glass product, the forming mandrel having at least one thermally stable ceramic material at a surface that contacts the primary glass product during forming, the at least one mold being configured so that the laser irradiates laser light on a region of the primary glass product not covered by the mold during forming;
a rotary device that rotates the at least one mold and the primary glass product relative to each other; and
a control device that controls the laser so that, at least intermittently, the primary glass product is heated by the laser light during forming.

21. The apparatus according to claim 20, wherein the at least one mold comprises a pair of rollers arranged in such a way that each roller rolls on the primary glass product as rotates by the rotary device and that a region on a periphery of the primary glass product lying between the rollers is illuminated by the laser light.

22. The apparatus according to claim 20, wherein the at least one mold is configured to compress the at least one portion of the primary glass product.

23. The apparatus according to claim 20, further comprising optics upstream of the laser, the optics being configured to distribute the laser light on the primary glass product within the region of the primary glass product being heated.

24. The apparatus according to claim 20, further comprising at least one forming station having the at least one mold.

25. The apparatus according to claim 20, further comprising a temperature measurement device for measuring a temperature of the primary glass product prior to or during forming, the control device regulating the laser based on the temperature measured by the temperature measurement device to adjust the region to a predetermined temperature.

26. The apparatus according to claim 20, wherein the at least one thermally stable ceramic material is selected from the group consisting of oxide ceramics, non-oxide ceramics, metal-ceramics, and any combinations thereof.

27. The apparatus according to claim 20, wherein the at least one thermally stable ceramic material is selected from the group consisting of zirconium oxide ceramics, aluminum titanate ceramics, silicate ceramics, aluminum nitride ceramics, aluminum oxide ceramics, silicon carbide ceramics, silicon nitride ceramics, and any combinations thereof.

28. The apparatus according to claim 20, wherein the at least one forming mandrel is free of tungsten and rhodium, at least in at the surface that contacts the primary glass product during forming.

29. A forming mandrel for forming glass products, comprising at least one thermally stable ceramic material at least in a region that forms a surface that contacts the glass products.

30. The forming mandrel according to claim 29, wherein the at least one thermally stable ceramic material is selected from the group consisting of oxide ceramics, non-oxide ceramics, metal-ceramics, and any combinations thereof.

31. The forming mandrel according to claim 29, wherein the at least one thermally stable ceramic material is selected from the group consisting of zirconium oxide ceramics, aluminum titanate ceramics, silicate ceramics, aluminum nitride ceramics, aluminum oxide ceramics, silicon carbide ceramics, silicon nitride ceramics, and any combinations thereof.

32. The forming mandrel according to claim 29, wherein the at least one thermally stable ceramic material is free of tungsten and rhodium, at least in at the surface that contacts the glass product during forming.

33. The forming mandrel according to claim 29, wherein the at least one thermally stable ceramic material has less than 0.5 wt % of tungsten and/or rhodium at least in at the surface that contacts the glass product during forming.

34. The forming mandrel according to claim 29, wherein the at least one thermally stable ceramic material has less than 0.1 wt % of tungsten and/or rhodium at least in at the surface that contacts the glass product during forming.

35. A process for forming glass products, comprising:
locally heating a region of a primary glass product to above its softening point by emitting laser light of a wavelength for which the primary glass product is at most partly transparent so that the laser light is absorbed at least partially in the primary glass product; and
forming at least one portion of the region with a mold having a forming mandrel comprising at least one thermally stable ceramic material at least in a region that forms a surface that contacts the primary glass product, the mold being configured so that a region of the portion of the primary glass product being formed is not covered by the mold;
rotating the forming mandrel and the primary glass product in relation to each other during the forming; and
irradiating the laser light on the region not covered by the mold during forming.

36. The process according to claim 35, further comprising controlling the laser light to intermittently heat the primary glass product light during the forming.

37. The process according to claim 35, wherein the step of forming at least one portion of the region with the mold comprises rolling a pair of rollers on the at least one portion of the region of the primary glass product, and
wherein the step of irradiating the laser light on the region not covered by the mold during forming comprises irradiating a periphery of the primary glass product lying between the pair of rollers.

38. The process according to claim 35, further comprising measuring a temperature of the primary glass product and controlling the laser light based on the temperature.

39. The process according to claims 35, further comprising reducing a power of the laser light irradiated during the forming process in comparison to the power during a pre-heating phase preceding the forming process.
